(19) United States
(12) Patent Application Publication
(10) Pub. No.: US 2012/0132687 A1
(43) Pub. Date: May 31, 2012

(54) FASTENER DRIVING TOOL

(75) Inventors: Tilo Dittrich, Feldkirch (AT); Heeb Norbert, Buchs (CH); Peter Stauss, Feldkirch (AT); Simon Beauvais, Horbranz (AT)

(73) Assignee: Hilti Aktiengesellschaft, Schaan (LI)

(21) Appl. No.: 13/302,107

(22) Filed: Nov. 22, 2011

(30) Foreign Application Priority Data
Nov. 25, 2010 (DE) 102010061979.5

(51) Int. Cl. B25C 1/14

(52) U.S. Cl. 227/10

(57) ABSTRACT

The invention relates to a fastener driving tool comprising a tank (5) for storing a fuel, in particular liquefied petroleum gas, a combustion chamber (2) connected to the tank, wherein the combustion chamber (2) has a movable piston for powering a driving plunger, and a metering device (4) arranged between the tank (5) and the combustion chamber (2), wherein a defined quantity of fuel can be transported by means of the metering device (4) from a metering space (12) into the combustion chamber, wherein the metering device (4) comprises an electric stepper motor (15) by means of which the defined amount can be varied as a function of a temperature.

The invention relates to a fastener driving tool, more particularly a hand-held fastener driving tool according to the preamble of claim 1.

DE 102 60 703 A1 describes a liquid gas-driven fastener driving tool that has a metering chamber with an adjustable metering space. The metering space can be varied by an electric motor drive, and an ejection of liquefied petroleum gas into a combustion chamber is initiated by a pneumatic drive by means of compressed air.

The problem of the invention is to specify a fuel driven fastener driving tool that allows an adjustment to variable operating conditions.

This problem is solved for a fastener driving tool of the type mentioned above by the characterizing features of claim 1. The use of an electrical stepper motor enables a precise adjustment of the fuel quantity to be metered with a simultaneous low consumption of electric power.

The temperature-dependent variation of the quantity of fuel introduced into the combustion chamber by means of the stepper motor guarantees reliable ignition and a uniform functioning of the fastener driving tool in a simple manner, even if the ambient temperatures or operating temperatures for the tool change. Depending on requirements, the relevant temperature can be, for example, the temperature in the area of or inside of the combustion chamber, or the ambient temperature of the tool.

It is taken into consideration that, especially if liquefied petroleum gas is used as the fuel, a phase change is required in order to produce an ignitable gas-air mixture, the kinetics of this process being influenced significantly by the prevailing temperatures. A generally known procedure, for example, is to increase the quantity of liquefied petroleum gas introduced into the combustion chamber at low ambient temperatures in order to be able to provide a sufficient amount of ignitable gas in a sufficiently short time.

A stepper motor within the meaning of the invention is understood to be any electric motor and/or servo drive that can be moved by a minimum step or an integer multiple thereof. Preferably, but not necessarily, stepper motors with self-holding are used, which provides additional security against an inadvertent adjustment of the metering device. The stepper motor can also preferably, but not necessarily, be constructed as a unipolar stepper motor, in which the coils are only switched on or switched off.

In a preferred embodiment, it is provided that the metered volume can be changed by a displacement of the stepper motor. This yields a particularly simple and effective configuration of the invention that allows easy metering by, for example, measuring the fuel in an adjustable metering space as an intermediate storage area by opening and closing valves connected to the variable metering space. The stepper motor can function here as an actuator that varies a limiting wall or diaphragm of the metering space.

In an alternative or supplementary embodiment of the invention, the metering device comprises a movable displacement member for ejecting the defined amount of fuel, with the stop position of the displacement member being variable by the stepper motor. These embodiments generally have the advantage that the displacement member enables a particularly rapid transport of the fuel into the combustion chamber. In particular, such a displacement member can, but need not necessarily, be constructed as a linearly displaceable piston or the like. The metered amount of fuel can be the product of the piston stroke and its cross-sectional area, the piston stroke being variable by means of the variable stop.

It is preferably assumed within the meaning of the present invention that the fuel is metered predominantly or exclusively in the liquid phase, whereby the amount of fuel introduced into the combustion chamber is defined especially precisely. With liquefied petroleum gas as the fuel, such an exclusive metering in the liquid phase can be ensured, for example, by arranging a diaphragm in the fuel tank, wherein the liquefied petroleum gas is kept exclusively in the liquid phase inside the diaphragm and an inert gas under a defined positive pressure is provided outside the diaphragm, for example. As the fuel is consumed, the inert gas expands due to its positive pressure and keeps the liquefied petroleum gas in the liquid phase at all times. Such a conventionally known configuration of a fuel tank is accompanied in practice as a matter of course by a certain variation of the pressure in the fuel tank as it is being emptied. That constitutes a difference from conventional storage containers for liquefied petroleum gas, in which liquefied gas is stored in a coexistence of gaseous and liquid phases in a constant volume, and thus provides a constant pressure.

In another preferred detailed design of the invention, a drive mechanism of the displacement member can be powered via a pressure of the fuel, in particular via a connection to the fuel tank. This makes it possible to forgo additional drive mechanisms, such as electrical and pneumatic drives, for the displacement member cost-effectively. Finally, the mechanical energy stored in the fuel tank is intelligently used to enable the metering of the fuel into the combustion chamber quickly and precisely.

In another detailed design, the displacement member can be held in an initial position under a force, preferably but not necessarily by means of a spring. In a simple manner, this ensures a defined starting position of the displacement member before initiation of the metering process.

In a particularly preferred embodiment of the invention, the metering device does not include a sensor for measuring the defined amount of fuel. Any sensors that may be present in the fastener driving tool are arranged outside the metering device. The forgoing of a measuring sensor, for example one for feeding back the motor position or the position of a stop or a variable wall of the metering space is especially favored by the use of a stepper motor according to the invention, since the adjusted amount of fuel can be controlled sufficiently precisely by the precise incremental movement of the motor. In an alternative configuration of the invention, such a sensor can also be provided, depending on the requirements. For example, the movement of the stepper motor can be determined by comparison of a target position to an actual position determined by the sensor.

It is advantageously provided in general that a basic setting of the defined quantity can be determined by an initialization routine of the stepper motor. The stepper motor is preferably, but not necessarily, driven up to a defined stop. In that way, a defined state of the metering device can be created, for example, after a reset of the fastener driving tool, a battery replacement, a replacement of the fuel tank, etc

The stepper motor is advantageously connected to a self-locking transmission preferably, but not necessarily, in the form of a linear actuator. Self-locking transmissions such as thread prevent a loss of adjustment of the set metering amount in a simple manner

In a generally advantageous detailed design, the metering device comprises at least one valve member, the valve member being preferably driven electrically. Further advantageously, the valve member can be constructed as a three-way valve, in particular with two switching positions, in the interest of a simple and effective realization. Overall this allows a simple and reliable control of the metering device. Further advantageously, the two switching positions of the three-way valve can be constructed as bistable positions, whereby a particularly low consumption of electric energy for the valve member becomes possible.

It is provided in a generally advantageous manner that a characteristic curve of the defined fuel quantity as a function of an ambient temperature has a substantially bilinear progression. This can be advantageously used so that the metered fuel quantity is varied only in the low temperature range, for example, while a constant amount of fuel is metered after reaching a certain limit temperature, in the range of an ambient temperature of 20° C., for example

Further advantages and characteristics of the invention follow from the embodiment examples described below, and from the dependent claims.

Several embodiment examples of the invention will be described below and explained in detail with reference to the attached drawing.

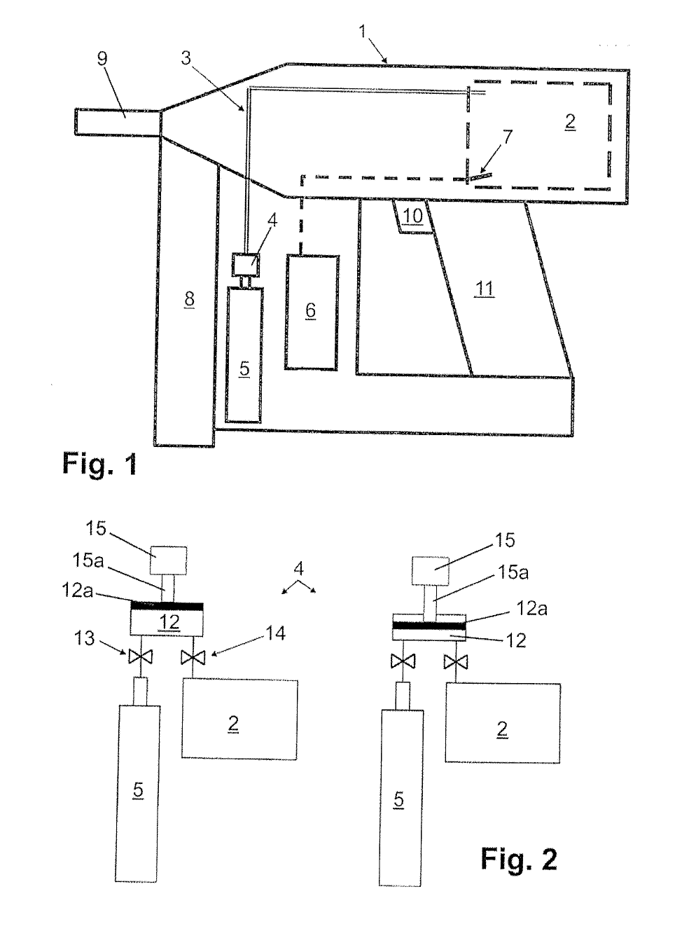

FIG. 1 shows a schematic overall view of a fastener driving tool according to the invention.

FIG. 2 shows a schematic representation of a first embodiment of the invention at low and high temperatures.

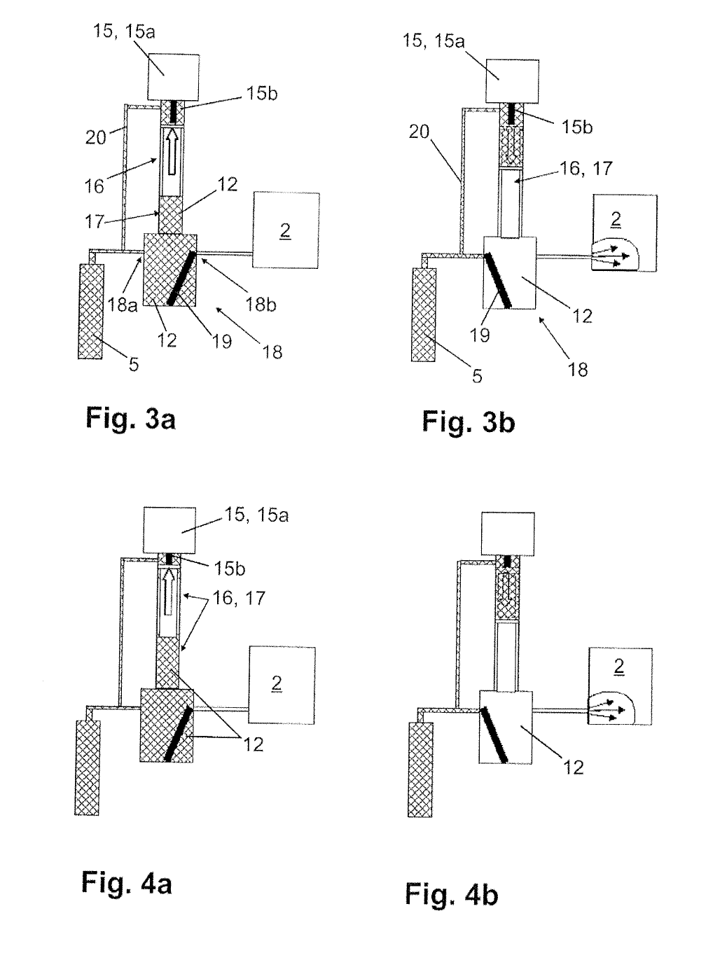

FIG. 3a shows a second embodiment example of the invention at high temperatures in a standby state of the metering device

FIG. 3b shows the embodiment example from FIG. 3a during a metering of the fuel.

FIG. 4a shows the embodiment example from FIG. 3a at low temperatures.

FIG. 4b shows the embodiment example from FIG. 4a during a metering of the fuel.

The fastener driving tool shown schematically in FIG. 1 comprises a housing 1 in which a combustion chamber 2 is arranged. Liquefied petroleum gas is stored as fuel in a fuel tank 5 and can be injected into the combustion chamber 2 via a line 3. The line 3 connects a metering device 4 to the combustion chamber 2, the metering device 4 being in turn connected to a fuel tank 5 arranged in or on the housing 1. In particular, the fuel tank can be constructed as a replaceable cartridge.

The fastener driving tool further comprises an electronic controller 6 with an electrical storage battery as the energy source. An electronic controller 6 controls a spark plug 7 in the combustion chamber 2, and optionally the metering device 4 as well, if the latter has electric valves or other electrically controlled opponents. A magazine 8 for storing fastening means such as nails is arranged in an anterior area of the driving tool. A contact member 9 can be pressed against a workpiece in order to enable triggering of the fastener driving tool.

A fastening member from the magazine 8 is driven in by the ignition of a liquid petroleum gas-air mixture in the combustion chamber 2 by means of the spark plug 7, after which a piston (not shown) is driven forward and drives the fastening member or the nail into the workpiece via a driving plunger (not shown). This driving process is initiated by an operator via a switch 10, which is arranged in a handle area 11 of the housing 1 in this case.

FIG. 2 shows a first embodiment example of the metering device 4. The metering device 4 comprises a metering space 12 that is connected via an input-side electrically controllable valve 13 to the fuel tank 5 and via an output-side electrically controllable valve 14 to the combustion chamber 2.

An adjusting unit with a stepper motor 15 is located on the metering space. The adjustment unit is connected via a self-locking transmission, constructed in the present case as a thread 15a, to an elastic or displaceable wall 12a of the metering space 12, the size of the metering space changing as a function of an adjustment of the stepper motor 15. The stepper motor 15 is displaced via a central electronic controller 6. For this purpose, the temperature is measured by means of a temperature sensor, not shown, and read out by the control unit. The stepper motor 15 is then rotated by means of a characteristic curve stored in the control unit in such a manner that the metering space is adjusted to the temperature according to the characteristic curve. The temperature sensor can measure an ambient temperature or a temperature of the combustion chamber 2, for example. It is also conceivable for several temperature sensors to be provided.

The illustration on the left in FIG. 2 shows a position of the stepper motor 15 or metering space 12 at a low temperature, with maximum metering space. The illustration on the right shows a corresponding limit position for a high temperature, in particular, for temperatures above 20° C.

The metering device according to FIG. 2 functions as follows:

First the input-side valve 13 is opened by means of the controller 6, so that liquefied petroleum gas can flow in a liquid phase into the metering space 12 adjusted by the stepper motor 15. The liquefied petroleum gas in tank 5 is only present in the liquid phase. This is accomplished in a conventional manner by enclosing the liquefied petroleum gas in the tank in a membrane and filling the area outside the membrane with an inert gas under a pressure higher than the vapor pressure of the liquefied petroleum gas. Due to this positive pressure, no evaporation process takes place following the flowing of the liquefied petroleum gas into the metering space 12, so that there is essentially no change of temperature following the flowing of the liquid gas.

When the fastener driving tool is triggered, the input-side valve 13 is closed and the output-side valve 14 is opened so that the liquid petroleum gas can flow into the combustion chamber 2. The amount of liquid metered into the combustion chamber 2, depending on the displacement of the stepper motor 15 or of the movable delimitation 12a of the metering space 12, is larger at lower temperatures so that even with a slower evaporation, an ignitable mixture is provided in the combustion chamber 2 sufficiently quickly.

FIGS. 3a through 4b show a second embodiment example of the invention. An essential difference from the previous embodiment example is that the liquefied petroleum gas is ejected from the metering space 12 by means of a movable displacement member 16.

The displacement member 16 is constructed as a linearly movable piston located in a cylinder 17 that is part of the metering space 12. The cylinder 17 adjoins an electrically driven valve member 18 that also has a connection to the fuel tank 5 and a connection to the combustion chamber 2 in addition to its connection to the cylinder 17. A valve slide 19 closes either the connection 18a to the fuel tank 5 or the connection 18b to the combustion chamber 2. Overall, the valve member 18 is constructed as a 3-way valve with two valve positions.

Depending on requirements, the positions of the valve slide 19 can each be stable positions (bistable valve slide) so that only a short electrical pulse requiring little energy is necessary to change the valve over. In another embodiment, the valve slide 19 is always arranged as in FIG. 3a in a deenergized rest position, i.e., closing the connection 18b to the combustion chamber 2 (monostable valve slide). By applying an electrical voltage, the valve slide is brought into the opposite position (see FIG. 3b), in which it closes the connection 18a to the fuel tank 5.

In each position of the valve slide 19, the cylinder 17 of the metering space 12 remains connected to the valve member 18. The valve member 18 comprises a certain intrinsic volume, which contributes to the metering space 12.

A branch line 20 leads from the connection of the fuel tank 5 and valve member 18 to an end of the cylinder 17 facing away from the valve member 18. The branch line 20 connects an upper end of the piston-like displacement member 16 to the fuel tank.

A stepper motor 15 with a self-locking transmission 15a (shown schematically as an integrated unit in FIG. 3a), by which an upper stop 15b for the displacement member 16 is temperature-dependently adjustable, is arranged in this upper end of the cylinder 17. According to the illustration in FIG. 3a, which corresponds to a high ambient temperature, the stop is provided by a temperature-dependently adjustable stop pin 15b that projects relatively far into the cylinder 17 in order to effect a smaller stroke for the piston 16.

The piston 16 is also tensioned by means of a spring (not shown) into its upper stop position, as is symbolized by the upward-directed arrow in FIGS. 3a and 4a. In this starting position according to FIGS. 3a and 4a, the pressure of the fuel tank 5 is present in the cylinder 17 both above and below the piston 16. The spring force only serves to provide a defined positioning of the piston 16 in a starting position. The force of the positioning spring can accordingly be relatively small.

A triggering process of the fastener driving device now takes place by switching the valve slide of the valve member 19 into the opposite position. Thereby the lower part of the cylinder 17, which is connected to the valve member 18, is connected via the connection 18b to the combustion chamber 2, in which there is a considerably lower pressure (ambient pressure). Above the piston 16, the cylinder 17 continues to be subjected via the line 20 to the pressure in the fuel tank 5. Thereby the piston 16 is accelerated downward according to the drawings, or in the direction of the valve member 18, pressing the liquefied petroleum gas out of the metering space 12, i.e, the lower part of the cylinder 17 and the volume in the valve member 18, into the combustion chamber 2. After this process, the piston 16 has reached a lower stop position shown in FIGS. 3b and 4b. According to this process, the displacement member 16 is driven by the pressure of the fuel in the tank 5.

For clarity, the volume areas in which the liquefied petroleum gas is in equilibrium in the liquid phase or under high pressure are shown in FIGS. 3a through 4b with crosshatching.

The adjustment unit consisting of stepper motor 15, transmission 15a and stop pin 15b is driven by the electronic control unit 6. A relative adjustment of the stop pin 15b is possible at any time by means of the controlled number of movement steps of the stepper motor.

In order to be able to secure the absolute position as well as the relative adjustment, the adjusting device and the control electronics have an initialization routine in the present case. Therein the stepper motor is specifically displaced in one of its movement directions up to a stop, this stop corresponding to a well-defined absolute position of the stop pin 15b or a metered fuel quantity, due to an appropriate mechanical design. For example, this can be a stop in the direction of a maximum length of the stop pin 15b.

Starting from this mechanically defined position, precise information on the adjustment of the stop pin is provided by means of a relative displacement. This initialization routine can be performed in defined time intervals, or after the replacement of a battery and/or the fuel tank.

Two alternative methods can be used for the movement up to the stop:

a) The motor is moved with a sufficient number of steps that it will certainly collide with the stop. The motor is under load for a brief time after reaching the stop, but movement is mechanically blocked.

b) The motor is driven in the direction of the stop, with the current-voltage curve being monitored by the controller 6. The motor is switched off as a result of the change in the characteristic curve when the stop is reached.

It is generally advisable to drive the stepper motor 15 at a higher frequency for the initialization routine, since the force against the stop is thereby smaller.

In an alternative embodiment example of the invention (not shown), a sensor that measures the current position of the adjustment device, and therefore indicates an absolute position directly, can also be provided in place of or in addition to the above-described initialization routine.

In practice and when using ordinary liquefied petroleum gas such as propane or propane-butane mixtures, it has been found that a change of the metering space or the liquid petroleum gas amount introduced into the combustion chamber makes sense in ranges below roughly 20° C. to 25° C. At higher temperatures, such a regulation is no longer very effective and the metering space is preferably held constant in these temperature ranges.

1. A fastener driving tool, comprising:
a tank for storing a fuel,
a combustion chamber connected to the tank, wherein the combustion chamber has a movable piston for powering a driving plunger, and
a metering device arranged between the tank and the combustion chamber,
wherein a defined quantity of fuel can be transported by means of the metering device from a metering space into the combustion chamber, and
the metering device comprises an electrical stepper motor by means of which the defined quantity can be varied as a function of one or more physical parameters.

2. The fastener driving tool according to claim 1, wherein the metering space can be changed by a movement of the stepper motor.

3. The fastener driving tool according to claim 1, wherein the metering device comprises a movable displacement member for ejecting the defined quantity of fuel, the displacement member having a stop position that can be varied via the stepper motor.

4. The fastener driving tool according to claim 3, wherein a drive mechanism of the displacement member can be driven by a pressure of the fluid via a connection to the tank.

5. The fastener driving tool according to claim 3, wherein the displacement member is held in an initial position under application of force by means of a spring.

6. The fastener driving tool according to claim 1, further comprising sensors, wherein all sensors are arranged outside of the metering device.

7. The fastener driving tool according to claim 1, wherein a basic setting of the defined quantity can be determined by an initialization routine of the stepper motor wherein the stepper motor is driven against a defined stop.

8. The fastener driving tool according to claim 1, wherein the stepper motor is connected to a self-locking transmission.

9. The fastener driving tool according to claim 1, wherein the metering device comprises at least one valve member wherein the valve member is operated electrically.

10. The fastener driving tool according to claim 9, wherein the valve member is constructed as a 3-way valve.

11. The fastener driving tool according to claim 1, wherein the one or more physical parameters comprise one or more ambient parameters, and/or one or more gas metering parameters, and/or one or more tool parameters.

12. The fastener driving tool according to claim 11, wherein the one or more ambient parameters comprise temperature and/or air pressure and/or the one or more gas metering parameters comprise metering pressure and/or the one or more tool parameters comprise tool temperature.

13. The fastener driving tool according to claim 2, wherein the metering device comprises a movable displacement member for ejecting the defined quantity of fuel, the displacement member having a stop position that can be varied via the stepper motor.

14. The fastener driving tool according to claim 13, wherein a drive mechanism of the displacement member can be driven by a pressure of the fluid via a connection to the tank.

15. The fastener driving tool according to claim 4, wherein the displacement member is held in an initial position under application of force by means of a spring.

16. The fastener driving tool according to claim 13, wherein the displacement member is held in an initial position under application of force by means of a spring.

17. The fastener driving tool according to claim 10, wherein the 3-way valve has two switching positions.

18. The fastener driving tool according to claim 9, wherein for at least one value member is operated electrically.

19. The fastener driving tool according to claim 18, wherein the valve member is constructed as a 3-way valve.

20. The fastener driving tool according to claim 19, wherein the stepper motor is connected to a self-locking transmission.
